(19) United States
(12) Patent Application Publication
(10) Pub. No.: US 2004/0131000 A1
(43) Pub. Date: Jul. 8, 2004

(54) Optical head device and objective lens for optical head device

(75) Inventors: Kenichi Hayashi, Nagano (JP); Yoshifusa Miyasaka, Nagano (JP); Yuji Fujita, Nagano (JP); Tetsuro Okamura, Nagano (JP)

Correspondence Address: HOGAN & HARTSON L.L.P., 500 S. GRAND AVENUE, SUITE 1900, LOS ANGELES, CA, 90071-2611, US

(73) Assignee: SANKYO SEIKI MFG. CO., LTD.

(21) Appl. No.: 10/705,807

(22) Filed: Nov. 10, 2003

(30) Foreign Application Priority Data
Dec. 2, 2002 (JP) 2002-350432

(51) Int. Cl. G11B 7/135

(52) U.S. Cl. 369/112.07; 369/121; 369/112.08

(57) ABSTRACT

An optical head device includes a first laser light source that emits a first laser beam with a first wavelength, a second laser light source that emits a second laser beam with a second wavelength which is different from that of the first laser beam, a common objective lens that converges the first laser beam on a recording surface of a first optical recording medium and the second laser beam on a recording surface of a second optical recording medium, a refraction surface that is formed on the common objective lens so as to be divided into a center side refraction surface region around an optical axis of the common objective lens and an outer peripheral side refraction surface region surrounding the center side refraction surface region and a center side diffraction grating that is formed all over the center side refraction surface region and is provided with a number of minute steps in a concentrically circular shape. A step height of the minute steps of a prescribed portion including a most inner side minute step of the center side diffraction grating is set to correspond to the first wavelength of the first laser beam, and a step height of remaining minute steps of the center side diffraction grating is set to correspond to the second wavelength of the second laser beam, and the outer peripheral side refraction surface region of the common objective lens is formed to have a refracting power corresponding to the second laser beam.

### BACKGROUND OF THE INVENTION

1. Field of the Invention

The present invention relates to an optical head device that is used for recording on or reproducing from an optical recording medium such as a CD or a DVD having a substrate thickness different from each other by means of using laser beams having different wavelengths. Further, the present invention also relates to an objective lens that is suitable to be used in the optical head device.

2. Description of Related Art

CDs and DVDs that are different in the thickness of their transparent protective layers protecting its recording surface and in their recording densities are known as optical recording media. A first laser light source emitting a first laser beam with a wavelength of 780 nm is used to reproduce and record data on a CD-R and a second laser light source emitting a second laser beam with a wavelength of 650 nm is used to reproduce data from a DVD.

For example, a conventional optical head device for performing recording and reproduction of data on or from an optical recording medium is constituted so that a laser beam converges on the recording surface of a CD or a DVD by means of a common objective lens to attain its miniaturization and compactness.

The thickness of the transparent protective layer of a CD protecting its recording surface is 1.2 mm. The thickness of the transparent protective layer of a DVD is 0.6 mm, which is thinner than that of CD, and its recording density is higher than that of a CD. Therefore, an objective lens used for the optical head device is constituted in such a manner that its lens surface having a single refracting power is provided with a diffraction grating formed of minute steps in a concentrically circular shape and the diffraction grating diffracts incident light beams so as to form different focus points at different positions on an optical axis.

The height of the steps of the diffraction grating is required to correspond to the wavelength of the laser beam. However, the diffraction grating is respectively incident the first laser beam with the wavelength of 780 nm to reproduce or record on a CD-R and the second laser beam with the wavelength of 650 nm to reproduce from a DVD. Accordingly, when the height of the step of the diffraction grating is formed to correspond to the wavelength of the second laser beam, a satisfactory resolution is obtained for a DVD but an S-curve characteristic is not obtained for a CD as shown in the S-curve characteristic (focusing error signal) in FIG. 6(a). On the other hand, when the height of the step of the diffraction grating is formed to correspond to the wavelength of the first laser beam, a satisfactory resolution is obtained for a CD but the amplitude of its S-curve characteristic is small for a DVD as shown in the S-curve characteristic (focusing error signal) in FIG. 6(b). Therefore, this diffraction grating is not usable for an optical recording medium with a two-layer structure. Further, when the height of the step is formed to correspond to the middle value of the respective wavelengths of both the laser beams, satisfactory S-curves are not obtained for both of a DVD and a CD as shown in the S-curve characteristics (focusing error signal) in FIG. 6(c).

### SUMMARY OF THE INVENTION

In view of the problems described above, it is an advantage of the present invention to provide an optical head device which can obtain good picking-up characteristics even in the case that a first laser beam and a second laser beam in which their wavelengths are different from each other are converged on recording surfaces of a first and a second optical recording media through an objective lens that is provided with a diffraction lens constitution, and to provide an objective lens for the optical head device described above.

In order to achieve the above advantage, according to the present invention, there is provided an optical head device including a first laser light source that emits a first laser beam with a first wavelength, a second laser light source that emits a second laser beam with a second wavelength that is different from that of the first laser beam, and a common objective lens that converges the first laser beam on a recording surface of a first optical recording medium and the second laser beam on a recording surface of a second optical recording medium. The objective lens is provided with a refraction surface that is divided into a center side refraction surface region formed around an optical axis of the objective lens and an outer peripheral side refraction surface region surrounding the center side refraction surface region. The center side diffraction grating is formed all over the center side refraction surface region so as to be provided with a number of minute steps in a concentrically circle-shape. The step height of the minute steps of a prescribed portion including the most inner side minute step of the center side diffraction grating is set to correspond to the first wavelength of the first laser beam and the step height of the remaining minute steps of the center side diffraction grating is set to correspond to the second wavelength of the second laser beam. Further, the outer peripheral side refraction surface region of the objective lens is formed to have a refracting power corresponding to the second laser beam.

In accordance with an embodiment of the present invention, the center side diffraction grating formed on the center side refraction surface region forms beam spots of the diffracted beams in the same order of the first and the second laser beams, that is, the first-order diffraction beam of the first and the second laser beams, on recording surfaces of the first and the second optical recording media by utilizing the difference of the wavelength. Therefore, the use efficiency of a laser beam can be improved by designing the diffraction grating so as to maximize the diffraction efficiency of the first-order diffraction beam. Also, the step height of the minute steps of a prescribed portion including the most inner side minute step of the center side diffraction grating is set to correspond to the wavelength of the first laser beam and the step height of the remaining minute steps is set to correspond to the wavelength of the second laser beam. Therefore, although the step height of the steps of the center side diffraction grating is mainly set to correspond to the second optical recording medium, satisfactory picking-up characteristics can be obtained for the first optical recording medium.

In accordance with an embodiment of the present invention, the minute steps of the prescribed portion including the most inner side minute step of the center side diffraction grating may further be positioned at three outermost steps, four outermost steps or five outermost steps, which are located in the outermost peripheral portion of the center side diffraction grating.

In accordance with an embodiment of the present invention, the minute steps of the prescribed portion may be positioned at the first step and the second step located at the most inner side of the center side diffraction grating.

Preferably, in accordance with an embodiment of the present invention, the outer peripheral side refraction surface region of the objective lens is formed to have a refracting power that is suitable to form a beam spot of the second laser beam on the recording surface of the second optical recording medium. In the case that the diffraction grating is formed on the outer peripheral side refraction surface region, it is required to form minute steps with a narrow pitch. However, according to the embodiment, since the beam spot of the second laser beam is formed on the recording surface of the second optical recording medium by the refracting power, it is not required to form minute steps with a narrow pitch on the outer peripheral side refraction surface region and thus the production of the objective lens is easy.

Further, in accordance with another embodiment of the present invention, the outer peripheral side refraction surface region is provided with an outer peripheral side diffraction grating that is provided with a number of minute steps formed in a concentrically circle shape all over the area of the outer peripheral side refraction surface region. The step height or the step difference of the outer peripheral side diffraction grating is formed to correspond to the wavelength of the second laser beam.

According to the optical head device having such a constitution, when the second optical recording medium is recorded or reproduced by using the second laser light source, the beam spot is formed by the first order diffraction light beam obtained through the central side refraction surface region and the first order diffraction light beam obtained through the outer peripheral side refraction surface region. Therefore, the step height of the outer peripheral side diffraction grating is preferably set to correspond the wavelength of the second laser beam.

Furthermore, in view of the problems described above, it is an advantage of the present invention to provide an objective lens for an optical head device, which converges the first laser beam on the recording surface of the first optical recording medium and the second laser beam on the recording surface of the second optical recording medium, including a refraction surface that is formed to be divided into a center side refraction surface region around an optical axis of the objective lens and an outer peripheral side refraction surface region surrounding the center side refraction surface region. A center side diffraction grating is formed all over the center side refraction surface region and is provided with a number of minute steps in a concentrically circle-shape. The step height of the minute steps of a prescribed portion including the most inner side minute step of the center side diffraction grating is set to correspond to the first wavelength of the first laser beam, and the step height of the remaining minute steps of the center side diffraction grating is set to correspond to the second wavelength of the second laser beam, and the outer peripheral side refraction surface region is formed to have a refracting power corresponding to the second laser beam.

According to the objective lens having such a constitution, similar constitutional features to the objective lens used in the above-mentioned optical head device may be provided on the present objective lens and an objective lens suitable to be used in the above-mentioned optical head device can be obtained.

Other features and advantages of the invention will be apparent from the following detailed description, taken in conjunction with the accompanying drawings that illustrate, by way of example, various features of embodiments of the invention.

### BRIEF DESCRIPTION OF DRAWINGS

FIG. 1 schematically shows a constitution of an optical system of an optical head device in accordance with an embodiment of the present invention.

FIG. 2(a) is a plan view showing the objective lens shown in FIG. 1. FIG. 2(b) is a cross-sectional view of the objective lens shown in FIG. 2(a). FIG. 2(c) is a partly enlarged cross-sectional view which shows the center portion of a center side refraction surface region around its optical axis, and FIG. 2(d) is a partly enlarged cross-sectional view which shows a boundary portion between the center side refraction surface region and an outer peripheral side refraction surface region surrounding the outside of the center side refraction face region.

FIG. 3 is an explanatory side view showing the convergence states of the first and the second laser beams with the use of the objective lens shown in FIG. 2.

FIG. 4(a) and FIG. 4(b) are respectively graphs showing an S-curve characteristic when the present invention is applied to the objective lens shown in FIG. 2.

FIG. 5 shows another embodiment of an objective lens in accordance with the present invention. FIG. 5(a) is a plan view of the objective lens. FIG. 5(b) is its cross-sectional view. FIG. 5(c) and FIG. 5(d) are respectively its partly enlarged cross-sectional views.

FIGS. 6(a), 6(b) and 6(c) are respectively graphs showing an S-curve characteristic with the use of conventional objective lens.

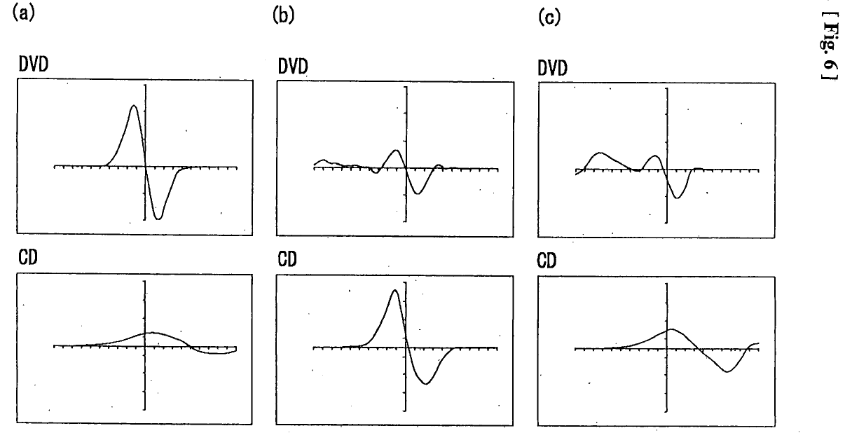

### DETAILED DESCRIPTION OF THE PREFERRED EMBODIMENTS

An optical head device provided with an objective lens in accordance with an embodiment of the present invention will be described below with reference to the accompanying drawings.

Entire Constitution

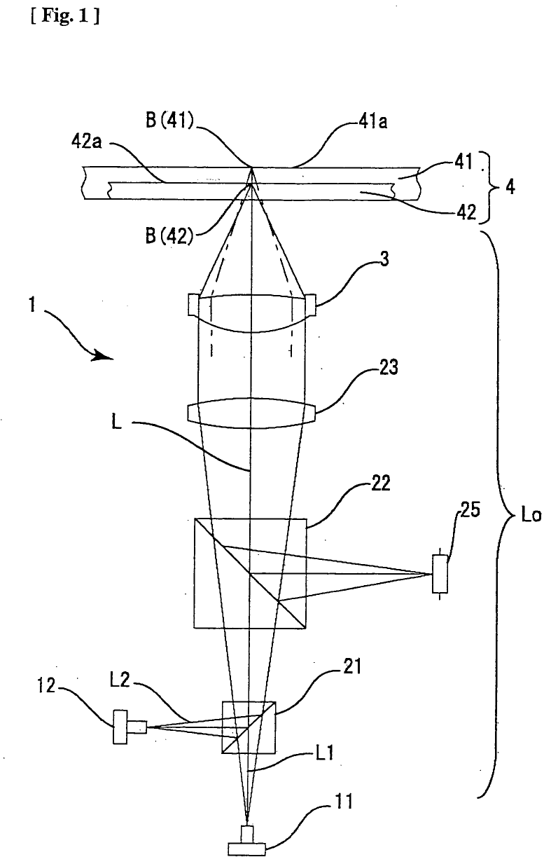

FIG. 1 schematically shows a structure of an optical system of an optical head device in accordance with an embodiment of the present invention.

In FIG. 1, an optical head device 1 in accordance with the present embodiment is constituted to perform recording and reproduction of data on or from optical recording media 4 such as CDs, CD-Rs, and DVDs, which are different in their substrate thickness and recording density. Therefore, the optical head device 1 is provided with a first laser light source 11 emitting a first laser beam L1 with a wavelength of 780 nm, which is used to reproduce and record data on a CD-R, and a second laser light source 12 emitting a second laser beam L2 with a wavelength of 650 nm which is used to reproduce data from a DVD. Each of the laser beams L1 and L2 is guided to an optical recording medium 4 through a common light converging optical system Lo and the return light of the respective laser beams reflected by the optical recording medium 4 is guided to a common light-receiving element 25.

The light converging optical system Lo includes a first beam splitter 21 in which a first laser beam L1 goes straight on and a second laser beam L2 is reflected so that both the light beams are aligned on a system optical axis L (optical axis of the objective lens) together, a second beam splitter 22 through which the laser beams L1 and L2 advanced along the system optical axis L are passed, a collimator lens 23 for forming a parallel beam of the respective laser beams L1 and L2 passing through the second beam splitter 22, and an objective lens 3 forming the beam spot of the laser beams L1 and L2 from the collimator lens 23 on the recording surface of the optical recording medium 4. The beam spot of the first laser beam L1 is formed on the recording surface 41a of a CD or a CD-R 41 by the objective lens 3 and the beam spot of the second laser beam L2 is formed on the recording surface 42a of a DVD 42 by the objective lens 3.

In the light converging optical system Lo, the return lights of the first and the second laser beams reflected by the light recording medium 4 are respectively reflected by the second beam splitter 22 and then converge on a common light receiving element 25.

According to the optical head device 1 having such a constitution, when a CD-R 41 as an optical recording medium 4 is used for reproduction or recording of data, the first laser beam L1 with the wavelength of 780 nm is emitted from the first laser light source 11. The first laser beam L1 is guided by the light converging optical system Lo and forms the beam spot B(41) on the recording surface 41a of the CD-R 41 through the objective lens 3. The return light of the first laser beam L1 reflected by the recording surface 41a of the CD-R 41 is reflected by the second beam splitter 22 and converges on the common light receiving element 25. And then, for example, the reproduction of data from the CD-R41 is performed by a signal detected by the common light receiving element 25.

Alternatively, when the reproduction of data from a DVD 42 as the optical recording medium 4 is executed, the second laser beam L2 with the wavelength of 650 nm is emitted from the second laser light source 12. The second laser beam L2 is also guided by the light converging optical system Lo and forms the beam spot B(42) on the recording surface 42a of the DVD 42 through the objective lens 3. The return light of the second laser beam L2 reflected by the recording surface 42a of the DVD 42 is reflected by the second beam splitter 22 to converge on the common light receiving element 25. Then, for example, the reproduction of data from the DVD 42 is performed by a signal detected by the common light receiving element 25.

Constitution of Objective Lens

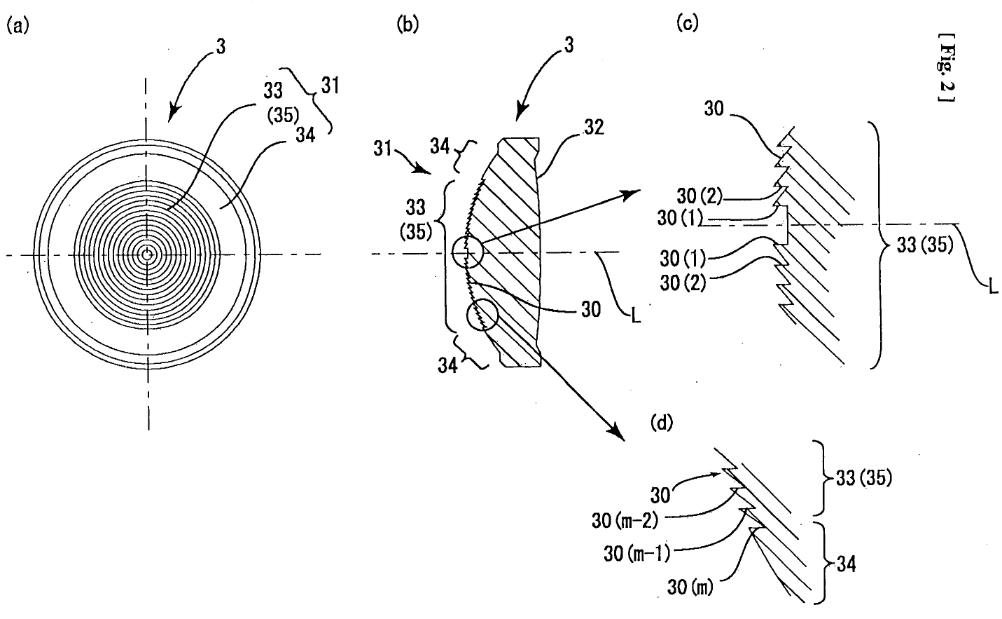

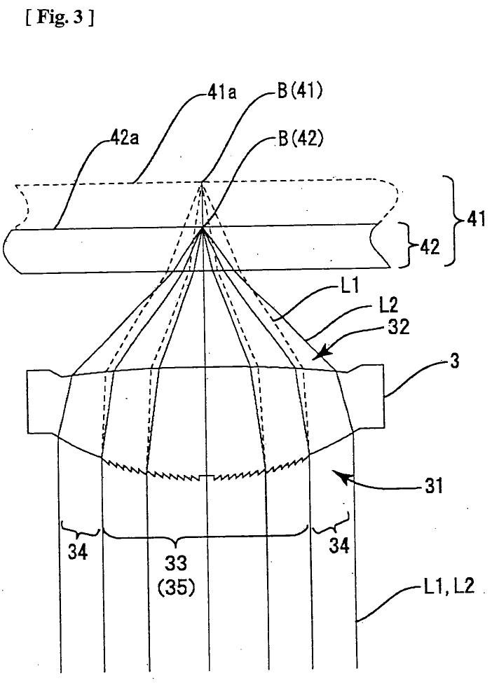

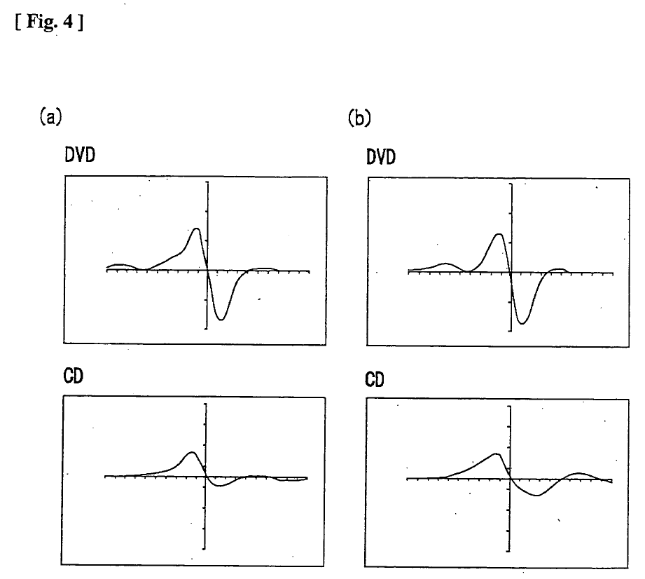

The constitution of the objective lens 3 in accordance with an embodiment of the present invention will be described below in detail with reference to FIGS. 2(a), 2(b), 2(c), 2(d) and 3. FIG. 2(a) is a plan view showing the objective lens 3, FIG. 2(b) is its cross-sectional view. FIG. 2(c) is a partly enlarged cross-sectional view which shows the center portion of a center side refraction surface region around its optical axis, and FIG. 2(d) is a partly enlarged cross-sectional view which shows a boundary portion between the center side refraction surface region and an outer peripheral side refraction surface region surrounding the outside of the center side refraction surface region. FIG. 3 is an explanatory side view showing the convergence states of the first and the second laser beams with the use of the objective lens 3. FIG. 4(a) and FIG. 4(b) are respectively graphs showing S-curve characteristics when the present invention is applied to the objective lens shown in FIG. 2.

(Basic Constitution of Objective Lens)

As shown in FIGS. 2(a) and 2(b), the objective lens 3 in this embodiment is a convex lens provided with an incident side refraction surface 31 having a positive power, to which the laser beam L1 emitted from the first laser light source 11 and the laser beam L2 emitted from the second laser light source 12 are incident, and an emitting side refraction surface 32 from which the respective laser beams are emitted toward the optical recording medium 4. The incident side refraction surface 31 is formed into two divided regions. One is a center side refraction surface region 33, which is formed in a circular shape so as to include the optical axis L and formed concentrically around the optical axis L as the center. The other is an outer peripheral side refraction surface region 34, which surrounds the outer peripheral portion of the center side refraction surface region 33 in a ring shape. The boundary portion between the center side refraction surface region 33 and the outer peripheral side refraction surface region 34 is preferably located at a position corresponding to the Numerical Aperture (NA)=0.45-0.55.

A center side diffraction grating 35 is provided with a number of minute steps 30, which are formed in a concentrically circle-shape, all over the area of the center side refraction surface region 33.

The center side refraction surface region 33 of the objective lens 3 is a refraction surface region having a refracting power which is different from that of the outer peripheral side refraction surface region 34. The center side diffraction grating 35 formed in the center side refraction surface region 33 is formed to have such a diffraction characteristic that the beam spot of the primary (first order) diffraction light beam of the first laser beam L1 passing through the center side refraction surface region 33 is formed on the recording surface of the CD-R 41. In addition, the center side diffraction grating 35 is also formed to have such a diffraction characteristic that the beam spot of the primary (first order) diffraction light beam of the second laser beam L2 passing through the center side refraction surface region 33 is formed on the recording surface of the DVD 42.

On the other hand, the outer peripheral side refraction surface region 34 of the objective lens 3 in this embodiment is formed to have such a refracting power that the beam spot of the beam portion of the second laser beam L2 passing through the outer peripheral side refraction surface region 34 is formed on the recording surface of the DVD 42. In other words, the grooves with a narrow pitch constituting a diffraction grating are not formed in the outer peripheral side refraction surface region 34. Therefore, the molding die for forming the objective lens 3 can be manufactured easily.

In the optical head device 1 provided with the objective lens 3 as constituted above, when data recorded on or reproduced from a CD-R 41, the first laser light source 11 is driven to emit the first laser beam L1. The beam portion of the first laser beam L1 passing through the center side refraction surface region 33 of the objective lens 3 is diffracted by the center side diffraction grating 35 to form the beam spot B(41) including of its primary (first order) diffraction light component on the recording surface of the CD-R 41 as shown by the dotted lines in FIG. 3. The outer peripheral side refraction surface region 34 of the objective lens 3 is formed to have the refracting power which forms the beam spot of the second laser beam L2 on the recording surface of a DVD 42. Therefore, the beam portion of the first laser beam L1 passing through the outer peripheral side refraction surface region 34 of the objective lens 3 is not used for the reproduction of data and does not converge on the recording surface of the CD-R 41 as a beam spot.

When data is reproduced from a DVD 42, the second laser light source 12 is driven to emit the second laser beam L2. As shown by the solid lines in FIG. 3, the beam portion of the laser beam L2 passing through the center side refraction surface region 33 of the objective lens 3 is diffracted by its center side diffraction grating 35 to generate the primary (first order) diffraction light component which forms the beam spot B(42) on the recording surface of the DVD 42. In addition, the beam portion of the second laser beam L2 passing through the outer peripheral side refraction surface region 34 of the objective lens 3 is also converged so that the beam spot B(42) is formed on the recording surface of the DVD 42.

(First Detailed Constitution of Center Side Diffraction Grating)

In FIGS. 2(a), 2(b), 2(c) and 2(d), the objective lens 3 used in the optical head device 1 in accordance with a first embodiment of the present invention is constituted as follows. The refractive index of the center side refraction surface region 33 is set to be “n”, and “m” rows of minute steps 30 are formed in a concentrically circular shape to constitute the center side diffraction grating 35 in the center side refraction surface region 33, wherein the most inner side of the steps 30 is designated as the step 30(1) and the most outer side of the steps 30 is designated as the step 30(m). The step height of the step 30(1) located at the most inner side and three steps 30(m), 30(m-1) and 30(m-2) located in the outermost peripheral portion of the center side diffraction grating 35 is set to be λ1/(n-1) or a value of approximately λ1/(n-1) between λ1/(n-1) and λ2/(n-1), which corresponds to the wavelength λ1 of the first laser beam. The step height of other remaining steps 30 is set to be λ2/(n-1), which corresponds to the wavelength λ2 of the second laser beam.

In the optical head device 1 with the use of the objective lens 3 constituted above, when a S-curve characteristic (focus error signal) is evaluated, the S-curve having an amplitude more than a prescribed required level is obtained for a DVD as shown in FIG. 4(a). This is because the step height of the steps 30 of the center side diffraction grating 35 is mainly set to correspond to the DVD (second laser beam). However, the step height of the step 30(1) located at the most inner side and the three steps 30(m), 30(m-1) and 30(m-2) located in the outermost peripheral portion of the center side diffraction grating 35 is set to correspond to the wavelength λ1 of the first laser beam. Therefore, a clear S-curve is obtained for a CD and, in addition, the center of the S-curve is located at the position where the best resolution is attained.

In this embodiment, “m” is an integer number from 20 to 30. That is, the number of the steps 30 of the center side diffraction grating 35 is from twenty to thirty. The number of the steps corresponding to the wavelength λ1 of the first laser beam is set fewer in comparison with the “m” number. This is because that the step 30(1) located at the most inner position contributes to a larger performance to obtain the clear S-curve for a CD as shown in FIG. 4(a).

In the above-mentioned embodiment, the step height of the step 30(1) located at the most inner side and the three steps 30(m), 30(m-1) and 30(m-2) located in the outermost peripheral portion of the center side diffraction grating 35 is set to be λ1/(n-1) or a value of approximately λ1/(n-1) between λ1/(n-1) and λ2/(n-1), which corresponds to the wavelength λ1 of the first laser beam. However, alternatively, the step height of the step 30(1) located at the most inner side and four steps 30(m) through 30(m-3) or five steps 30(m) through 30(m-4), which are located in the outermost peripheral portion, of the center side diffraction grating 35 is set to be λ1/(n-1) or a value of approximately λ1/(n-1) between λ1/(n-1) and λ2/(n-1), which corresponds to the wavelength λ1 of the first laser beam.

(Second Detailed Constitution of Center Side Diffraction Grating)

In FIGS. 2(a), 2(b), 2(c) and 2(d), the objective lens 3 used in the optical head device 1 in accordance with a second embodiment of the present invention is constituted as follows. The refractive index of the center side refraction surface region 33 is set to be “n”, and “m” rows of minute steps 30 are formed in a concentrically circular shape to constitute the center side diffraction grating 35 in the center side refraction surface region 33, wherein the most inner side of the steps 30 is designated as the step 30(1) and the most outer side of the steps 30 is designated as the step 30(m). The step height of the first step 30(1) and the second step 30(2) located at the most inner side of the center side diffraction grating 35 is set to be λ1/(n-1) or a value of approximately λ1/(n-1) between λ1/(n-1) and λ2/(n-1), which corresponds to the wavelength λ1 of the first laser beam. The step height of other remaining steps 30 is set to be λ2/(n-1), which corresponds to the wavelength λ2 of the second laser beam.

In the optical head device 1 with the use of the objective lens 3 constituted above, when a S-curve characteristic (focus error signal) is evaluated, the S-curve having an amplitude more than a prescribed required level is obtained for a DVD as shown in FIG. 4(b). This is because that the step height of the steps 30 of the center side diffraction grating 35 is mainly set to correspond to the DVD (second laser beam). However, the step height of the step 30(1) located at the most inner position and the next inner side step 30(2) of the center side diffraction grating 35 is set to be λ1/(n-1) or a value of approximately λ1/(n-1) between λ1/(n-1) and λ2/(n-1), which corresponds to the wavelength λ1 of the first laser beam. Therefore, a clear S-curve is obtained for a CD and, in addition, the center of the S-curve is located at the position where the best resolution is attained.

In this embodiment, the number of the steps corresponding to the wavelength λ1 of the first laser beam is only two. These steps are located at the innermost portion. However, as clearly shown in FIG. 4(b), the amplitude of the S-curve in a CD in this embodiment is larger than that in the embodiment shown in FIG. 4(a), that is, the step 30(1) located at the most inner side and the three steps 30(m), 30(m-1) and 30(m-2) located in the outermost peripheral portion are formed corresponding to the wavelength λ1 of the first laser beam. This result shows that the performance of the steps 30 located on the center side is larger.

(Another Embodiment of Objective Lens)

In the above-mentioned objective lens 3, the refracting power of the outer peripheral side refraction surface region 34 is set such that the beam portion of the second laser beam passing through the outer peripheral side refraction surface region 34 forms the beam spot on the recording surface of the DVD 42.

On the other hand, a diffraction grating may be formed on the outer peripheral side refraction surface region 34 so that the beam spot of the diffraction light component of the second laser beam is formed on the recording surface of the DVD 42 by the diffraction grating.

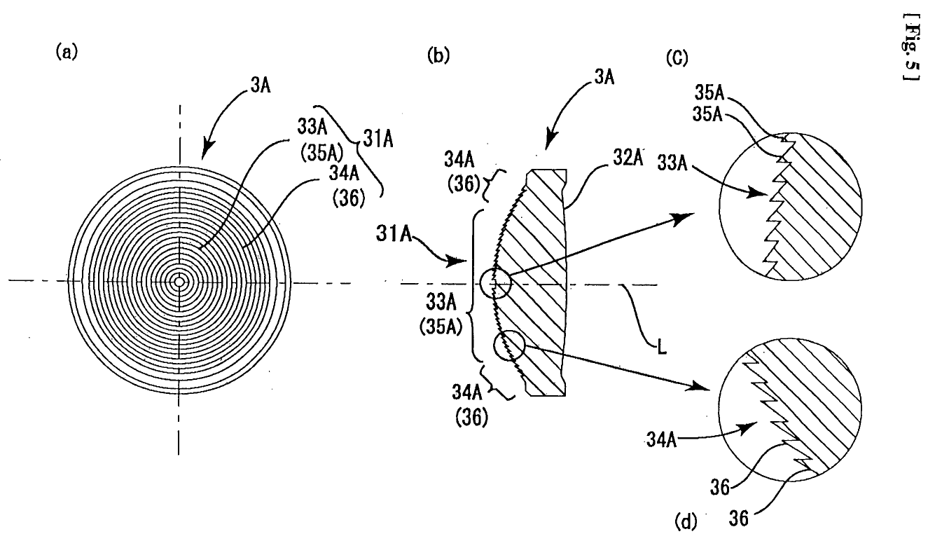

FIG. 5(a) is a plan view of an objective lens 3A in which a diffraction grating is formed in its outer peripheral refraction surface region, FIG. 5(b) is its cross-sectional view, and FIGS. 5(c) and 5(d) are respectively its partly enlarged cross-sectional views. As shown in these drawings, the objective lens 3A according to the present embodiment is a convex lens which is provided with an incident side refraction surface 31A having a positive power, to which the laser beam L1 emitted from the first laser light source 11 and the laser beam L2 emitted from the second laser light source 12 are made incident, and an emitting side refraction surface 32A for emitting the laser beam toward the optical recording medium.

The incident side refraction surface 31A is formed into two divided regions. One is a center side refraction surface region 33A which is formed in a circular shape including the optical axis L and formed concentrically around the optical axis L as the center. The other is an outer peripheral side refraction surface region 34A which surrounds the outer peripheral portion of the center side refraction surface region 33A in a ring shape. A center side diffraction grating 35A is provided with a number of minute steps 30 that are formed in a concentrically circular shape all over the area of the center side refraction surface region 33A. In addition, the outer peripheral side refraction surface region 34A is formed with an outer peripheral side diffraction grating 36, which is provided with a number of minute steps 30 that are formed in a concentrically circular shape all over the outer peripheral side refraction surface region 34A.

The objective lens 3A of the present embodiment forms the beam spot of the first laser beam L1 on the recording surface 41a of the CD-R 41 by using the beam portion passing through the central side refraction surface region 33A. Specifically, the beam spot B(41) is formed on the recording surface of the CD-R 41 by the primary diffraction light component of the first laser beam L1 which is generated by the diffraction effect caused by the central side diffraction grating 35A formed in the central side refraction surface region 33A.

The beam portion of the first laser beam L1 passing through the outer peripheral side refraction surface region 34A of the objective lens 3A is an unnecessary light for recording or reproduction of data. Therefore, in this embodiment, the beam portion passing through the outer peripheral side refraction surface region 34A is subjected to the diffraction effect by the outer peripheral side diffraction grating 36 formed in the outer peripheral side refraction surface region 34A to be diffracted so as not to converge on the beam spot forming position on the recording surface of the CD-R 41.

In addition, the objective lens 3A of the present embodiment forms the beam spot of the second laser beam L2, which is emitted at the time of reproduction of a DVD 42, on the recording surface 42a of the DVD 42. In other words, the beam portion of the laser beam L2 passing through the center side refraction surface region 33A of the objective lens 3 is diffracted by its center side diffraction grating 35A of the center side refraction surface region 33A to generate the primary diffraction light component which forms the beam spot B(42) on the recording surface of the DVD 42. In addition, the beam portion of the second laser beam L2 passing through the outer peripheral side refraction surface region 34A of the objective lens 3 is diffracted by the outer peripheral side diffraction grating 36 formed in the outer peripheral side refraction surface region 34A. And the beam spot B(42) is formed at the same position as that formed by the center side diffraction grating 35A on the recording surface of the DVD 42 by using the primary (first order) diffraction light component of the second laser beam L2 which is generated by the diffraction effect by the outer peripheral side diffraction grating 36.

According to the objective lens 3A having such a constitution, the effects similar to those of the objective lens 3 can be obtained. In addition, the objective lens 3A according to the present embodiment is provided with the outer peripheral side diffraction grating 36 in the outer peripheral side refraction surface region 34A in such a manner that the primary (first order) diffraction light component of the second laser beam L2 is generated to form the beam spot B(42). Therefore, the unnecessary light portion of the first laser beam L1 passing through the outer peripheral side portion is diffracted by the outer peripheral side diffraction grating 36 so as not to converge on the beam-spot forming position on the recording surface of the CD-R 41. Consequently, the unnecessary light can be surely eliminated without using a limiting aperture.

The objective lens 3A according to the embodiment is also constituted as follows. The refractive index of the center side refraction surface region 33A is set to be “n”, and “m” rows of the minute steps 30 are formed in a concentrically circular shape to constitute the center side diffraction grating 35A in the center side refraction surface region 33A, wherein the most inner side of the steps 30 is the step 30(1) and the most outer side of the steps 30 is the step 30(m). The step height of the step 30(1) located at the most inner side and three steps 30(m), 30(m-1) and 30(m-2) located in the outermost peripheral portion of the center side diffraction grating 35 is set to be λ1/(n-1) or a value of approximately λ1/(n-1) between λ1/(n-1) and λ2/(n-1), which corresponds to the wavelength λ1 of the first laser beam. The step height of other remaining steps 30 of the center side refraction surface region 33A and all the steps 30 of the outer peripheral side diffraction grating 36 is set to be λ2/(n-1), which corresponds to the wavelength λ2 of the second laser beam.

The objective lens 3A according to another embodiment of the present invention may be constituted as follows. The step height of the first step 30(1) and the second step 30(2) located at the most inner side of the center side diffraction grating 35A is set to be λ1/(n-1) or a value of approximately λ1/(n-1) between λ1/(n-1) and λ2/(n-1), which corresponds to the wavelength λ1 of the first laser beam. The step height of other remaining steps 30 of the center side refraction surface region 33A and all the steps 30 of the outer peripheral side diffraction grating 36 is set to be λ2/(n-1), which corresponds to the wavelength λ2 of the second laser beam.

According to the embodiment described above, an S-curve having the amplitude more than a prescribed required level is obtained for a DVD. This is because the step height of the steps 30 of the center side diffraction grating 35A is mainly set to correspond to the DVD (second laser beam). In addition, the step height including the most inner side of the center side diffraction grating 35A is set to be λ1/(n-1) or a value of approximately λ1/(n-1) between λ1/(n-1) and λ2/(n-1), which corresponds to the wavelength λ1 of the first laser beam. Therefore, similar to the embodiment described above, a clear S-curve is also obtained for a CD and, in addition, the center of the S-curve is located at the position where the best resolution is attained.

As described above, the optical head device and the objective lens for the optical head device according to the present invention includes the center side diffraction grating which is formed on the center side refraction surface region to form the beam spots of the diffracted beams in the same order (first order) of the first and the second laser beams on recording surfaces of the first and the second optical recording media by utilizing the difference of the wavelength. Therefore, the use efficiency of the laser beam can be improved by designing the diffraction grating so as to maximize the diffraction efficiency of the first-order diffraction beam.

Also, the step height of the minute steps of the prescribed portion including the most inner side minute step of the center side diffraction grating is set to correspond to the wavelength of the first laser beam and the step height of the remaining minute steps is set to correspond to the wavelength of the second laser beam. Therefore, although the step height of the steps of the center side diffraction grating is mainly set to correspond to the second optical recording medium, satisfactory picking-up characteristics can be also obtained for the first optical recording medium.

While the description above refers to particular embodiments of the present invention, it will be understood that many modifications may be made without departing from the spirit thereof. The accompanying claims are intended to cover such modifications as would fall within the true scope and spirit of the present invention.

The presently disclosed embodiments are therefore to be considered in all respects as illustrative and not restrictive, the scope of the invention being indicated by the appended claims, rather than the foregoing description, and all changes which come within the meaning and range of equivalency of the claims are therefore intended to be embraced therein.

What is claimed is:

1. An optical head device comprising:
a first laser light source that emits a first laser beam with a first wavelength;
a second laser light source that emits a second laser beam with a second wavelength which is different from that of the first laser beam;
a common objective lens that converges the first laser beam on a recording surface of a first optical recording medium and the second laser beam on a recording surface of a second optical recording medium;
a refraction surface that is formed on the common objective lens so as to be divided into a center side refraction surface region around an optical axis of the common objective lens and an outer peripheral side refraction surface region surrounding the center side refraction surface region; and
a center side diffraction grating that is formed all over the center side refraction surface region and is provided with a number of minute steps in a concentrically circular shape,
wherein a step height of the minute steps of a prescribed portion including a most inner side minute step of the center side diffraction grating is set to correspond to the first wavelength of the first laser beam, and a step height of remaining minute steps of the center side diffraction grating is set to correspond to the second wavelength of the second laser beam, and
the outer peripheral side refraction surface region of the common objective lens is formed to have a refracting power corresponding to the second laser beam.

2. The optical head device according to claim 1, wherein the minute steps of the prescribed portion including the most inner side minute step of the center side diffraction grating are located at either three outermost steps, four outermost steps or five outermost steps, which are located in an outermost peripheral portion of the center side diffraction grating.

3. The optical head device according to claim 1, wherein the minute steps of the prescribed portion are positioned at a first step and a second step located at the most inner side minute step of the center side diffraction grating.

4. The optical head device according to claim 1, wherein the outer peripheral side refraction surface region of the common objective lens is formed to have a refracting power that is suitable to form a beam spot of the second laser beam on the recording surface of the second optical recording medium.

5. The optical head device according to claim 1, further comprising:
an outer peripheral side diffraction grating that is formed on the outer peripheral side refraction surface region and is provided with a number of minute steps that are formed in a concentrically circular shape all over the area of the outer peripheral side refraction surface region,
wherein the step height of the minute steps of the outer peripheral side diffraction grating is set to correspond to the wavelength of the second laser beam.

6. The optical head device according to claim 1, wherein a boundary portion between the center side refraction surface region and the outer peripheral side refraction surface region is located at a position corresponding to a Numerical Aperture (NA) ranging from 0.45 to 0.55.

7. An objective lens comprising:
a refraction surface that is formed to be divided into a center side refraction surface region around an optical axis of the objective lens and an outer peripheral side refraction surface region surrounding the center side refraction surface region; and
a center side diffraction grating that is formed all over the center side refraction surface region and is provided with a number of minute steps in a concentrically circular shape,
wherein a step height of the minute steps of a prescribed portion including a most inner side minute step of the center side diffraction grating is set to correspond to a first wavelength of a first laser beam, and a step height of remaining minute steps of the center side diffraction grating is set to correspond to a second wavelength of a second laser beam having a wavelength different from the first wavelength, and
the outer peripheral side refraction surface region is formed to have a refracting power corresponding to the second laser beam.

8. The objective lens according to claim 7, wherein the minute steps of the prescribed portion including the most inner side minute step of the center side diffraction grating are located at either three outermost steps, four outermost steps or five outermost steps, which are located in an outermost peripheral portion of the center side diffraction grating.

9. The objective lens according to claim 7, wherein the minute steps of the prescribed portion are positioned at a first step and a second step located at the most inner side minute step of the center side diffraction grating.

10. The objective lens according to claim 7, wherein the outer peripheral side refraction surface region is formed to have a refracting power that is suitable to form a beam spot of the second laser beam on a recording surface of an optical recording medium.

11. The objective lens according to claim 7, further comprising:
an outer peripheral side diffraction grating that is formed on the outer peripheral side refraction surface region and is provided with a number of minute steps that are formed in a concentrically circular shape all over the area of the outer peripheral side refraction surface region,
wherein the step height of the minute steps of the outer peripheral side diffraction grating is set to correspond to the second wavelength.

12. The objective lens according to claim 7, wherein a boundary portion between the center side refraction surface region and the outer peripheral side refraction surface region is located at a position corresponding to a Numerical Aperture (NA) ranging from 0.45 to 0.55.

13. The optical head device according to claim 1, wherein the common objective lens is convex lens.

14. The optical head device according to claim 1, wherein the common objective lens includes an incident side refractive surface.

15. The objective lens according to claim 7 further comprising an incident side refractive surface.

16. The optical head device according to claim 14, wherein the incident side refractive surface has a positive power.

17. The objective lens according to claim 15, wherein the incident side refractive surface has a positive power.

18. The optical head device according to claim 1, wherein the first wavelength is 780 nm.

19. The optical head device according to claim 1, wherein the second wavelength is 650 nm.

20. A method of recording on or reproducing on an optical device comprising:
emitting a first laser beam with a first wavelength;
emitting a second laser beam with a second wavelength which is different from that of the first laser beam;
converging the first laser beam on a recording surface of a first optical recording medium and the second laser beam on a recording surface of a second optical recording medium;
providing a center side refraction surface region around an optical axis of the common objective lens and an outer peripheral side refraction surface region surrounding the center side refraction surface region;
forming a center side diffraction grating all over the center side refraction surface region having a number of minute steps in a concentrically circular shape;
forming a step height of the minute steps of a prescribed portion including a most inner side minute step of the center side diffraction grating set to correspond to the first wavelength of the first laser beam, and a step height of remaining minute steps of the center side diffraction grating set to correspond to the second wavelength of the second laser beam; and
forming the outer peripheral side refraction surface region to have a refracting power corresponding to the second laser beam.
